(19) United States
(12) Patent Application Publication
(10) Pub. No.: US 2025/0323567 A1
(43) Pub. Date: Oct. 16, 2025

(54) OPERATING MODE CONTROL TECHNIQUE FOR POWER FACTOR CORRECTION CIRCUITS

(71) Applicant: SEMICONDUCTOR COMPONENTS INDUSTRIES, LLC, Scottsdale, AZ (US)

(72) Inventors: Vaclav DRDA, Valasska Bystrice (CZ); Roman STULER, Karolinka (CZ)

(73) Assignee: SEMICONDUCTOR COMPONENTS INDUSTRIES, LLC, Scottsdale, AZ (US)

(21) Appl. No.: 18/637,126

(22) Filed: Apr. 16, 2024

(51) Int. Cl. H02M 1/42; H02M 1/44

(52) U.S. Cl. CPC H02M 1/4225; H02M 1/44

(57) ABSTRACT

A power factor correction (PFC) control circuit includes a pulse-width modulation (PWM) circuit configured to control a switch of a switching power converter. The PFC control circuit further includes a mode control circuit configured to select a conduction mode from a plurality of conduction modes for the switching power converter based at least in part on an output power of the switching power converter and to control a beginning of a switching cycle of the switching power converter based on the selected conduction mode. In addition, the PFC control circuit includes a current regulation circuit configured to provide a regulation signal to the PWM circuit to regulate an average coil current of the switching power converter in each of the plurality of conduction modes.

### TECHNICAL FIELD

The disclosure relates generally to power factor correction circuits, and particularly to a controller for controlling the conduction mode of a power factor correction circuit.

### BACKGROUND

Switching power converters can be used to create a direct current (“DC”) voltage from an alternating current (“AC”) voltage by switching current through a magnetic element such as an inductor. Offline converters receive a voltage from an AC source or mains and form a first voltage, which may then be converted into a different voltage. Typically, an AC input voltage is converted into a full-wave rectified voltage by a diode bridge rectifier and smoothed before being converted into a lower voltage for use by low-voltage circuitry. One type of offline switching power converter is a power factor correction (“PFC”) circuit. A PFC circuit may be used to ensure that power is being efficiently delivered to a load with a high power factor by keeping the current drawn from the AC source in phase with the AC voltage.

PFC circuits may be operated in one of multiple operating modes. In continuous conduction mode (“CCM”), a new switching cycle is initiated before the previous cycle's inductor current discharges to zero. In critical conduction mode (“CrM”), a new switching cycle is initiated soon after the inductor current reaches zero. In discontinuous conduction mode (“DCM”), the inductor current is allowed to decay to zero, and the switch subsequently remains off for a period of time before the next switching cycle is initiated. The inventors of embodiments of the present disclosure have recognized that different operating modes may be utilized to enhance PFC power converter characteristics, such as efficiency, power factor, and electromagnetic interference (“EMI”) under different operating conditions. The inventors of embodiments of the present disclosure have also recognized that different operating modes have required different control schemes, causing instability during the transition from one operating mode to another. Embodiments of the present disclosure may address one or more of these challenges.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1 illustrates a schematic diagram of a PFC circuit in accordance with embodiments of the present disclosure.

FIG. 2 illustrates a plot diagram of example waveforms within a boost converter in accordance with embodiments of the present disclosure.

FIG. 3 illustrates a block diagram of a reference generator in accordance with embodiments of the present disclosure.

FIG. 4 illustrates a block diagram of a mode control circuit in accordance with embodiments of the present disclosure.

FIG. 5A illustrates a plot diagram of a reference signal versus thresholds for determining the operating mode of a boost converter in accordance with embodiments of the present disclosure.

FIG. 5B illustrates a plot diagram of a current regulation reference signal and a minimum coil current threshold in accordance with embodiments of the present disclosure.

FIG. 6 illustrates a method for controlling a PFC circuit in accordance with embodiments of the present disclosure.

### DETAILED DESCRIPTION

Details of one or more embodiments are set forth in the description below and the accompanying drawings. Other features will be apparent from the description, drawings, and from the claims.

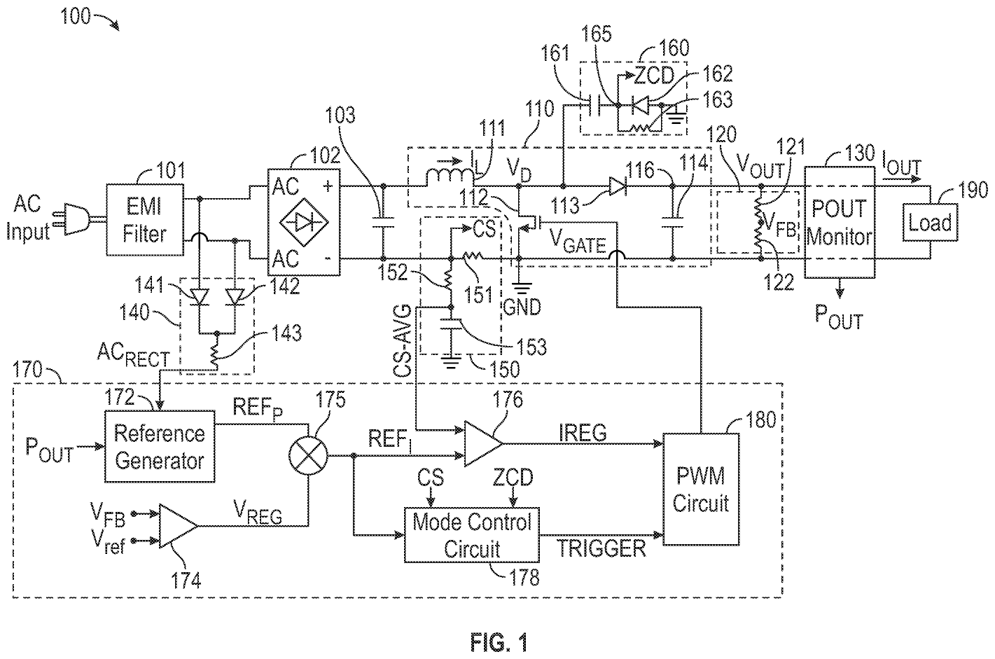

FIG. 1 illustrates a schematic diagram of PFC circuit 100. PFC circuit 100 may be implemented in any suitable fashion according to the operation described in the present disclosure. PFC circuit 100 may include EMI filter 101, diode bridge 102, input capacitor 103, boost converter 110, feedback network 120, power-output monitor 130, rectifier circuit 140, current-sense circuit 150, zero-cross circuit 160, and PFC control circuit 170. PFC circuit 100 may be configured to provide a regulated output voltage V_{OUT} to load 190. In some embodiments, load 190 may include electronic circuitry to be powered directly by PFC circuit 100. In other embodiments, load 190 may include one or more additional power-converter stages that may power electronic circuitry located downstream. For either such embodiments, PFC circuit 100 may ensure that power is being efficiently delivered to load 190 with a high power factor by keeping the current drawn from the AC input in phase with the AC input voltage.

The AC input for PFC circuit 100 may pass through EMI filter 101 to diode bridge 102. EMI filter 101 may filter high-frequency AC noise. EMI filter 101 may, for example, protect PFC circuit 100 from high-frequency noise on the AC line voltage received at the AC input. EMI filter 101 may also protect the AC line from high-frequency switching noise generated by PFC circuit 100. Diode bridge 102 may receive the filtered AC line voltage and output a rectified DC voltage. An input capacitor 103 may be coupled across the output of diode bridge 102. A rectified voltage may thus be established across input capacitor 103. As shown in FIG. 1, the voltage at input capacitor 103 may be provided to the input of a switching power converter, such as boost converter 110. Although filtered and rectified in the example embodiment shown in FIG. 1, the power drawn at the input of boost converter 110 may originate from the AC input of PFC circuit 100. Thus, for the purposes of the present disclosure, the AC input of PFC circuit 100 may also be referred to as the AC input of a switching power converter, or as the AC input of boost converter 110.

Boost converter 110 may be implemented in any suitable fashion according to the operation described in the present disclosure. As shown in FIG. 1, boost converter 110 may include inductor 111, switch 112, diode 113, bulk capacitor 114, and output 116. Switch 112 may be switched on and off repeatedly to convert the voltage at input capacitor 103 into a regulated output voltage V_{OUT} provided at output 116. When switch 112 is switched on, the inductor current I_{L} may flow through switch 112 to ground. During the on-time of switch 112, the inductor current I_{L} may increase over time. When switch 112 is switched off, the inductor current I_{L} may flow through diode 113 and to bulk capacitor 114. During the off-time of switch 112, the inductor current I_{L} may decrease over time. Although FIG. 1 illustrates that switch 112 may in some embodiments be an n-channel metal-oxide semiconductor field effect transistor (“NMOS” or “N-channel MOSFET”), switch 112 may be implemented by any suitable type of switch or transistor. The output voltage V_{OUT} of boost converter 110 may be regulated by controlling the duty cycle of switch 112. For the purposes of the present disclosure, the duty cycle of switch 112 may refer to the ratio of the on-time of switch 112 during a given switching cycle to the sum of the on-time and the off-time for that switching cycle. Although the example embodiment of boost converter 110 shown in FIG. 1 includes inductor 111, other embodiments may utilize any other suitable magnetic element, such as a first winding of a transformer or a first winding of a pair of coupled windings. The inductor current I_{L} through inductor 111 may thus also be referred to generally as the coil current I_{L}. Moreover, although FIG. 1 utilizes boost converter 110 as an example switching power converter, other embodiments of PFC circuit 100 may utilize other types of switching power converter topologies, such as a buck, a flyback, or a forward converter topology.

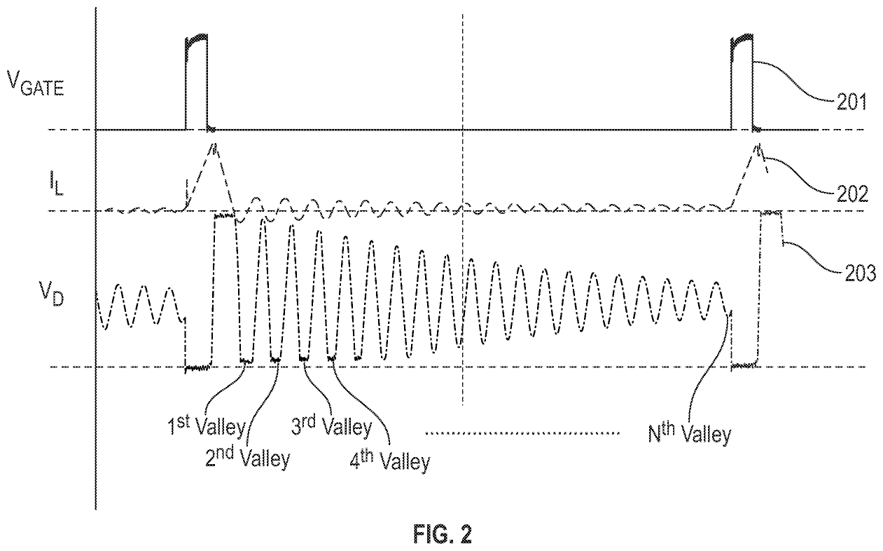

FIG. 2 illustrates a plot diagram of example waveforms within boost converter 110 in accordance with embodiments of the present disclosure. In particular, FIG. 2 illustrates example waveforms within boost converter 110 when boost converter 110 is operating in DCM. Plot 201 illustrates the gate voltage VGATE applied to switch 112 to turn switch 112 on and off. Plot 202 illustrates the coil current I_{L} through inductor 111. Plot 203 illustrates the voltage V_{D} at the drain of switch 112. During the switching of boost converter 110, the coil current I_{L} through inductor 111, and the voltage V_{D} at the drain of switch 112, may vary. For example, when switch 112 is on, the voltage at the drain of switch 112 may be a near-zero value equal to the on-resistance of switch 112 multiplied by the current through switch 112. As shown by plot 202, the coil current I_{L} through inductor 111 may increase with time during the on-time of switch 112. When switch 112 is subsequently switched from on to off, the voltage at the drain of switch 112 may rise sharply to a value approximately equal to V_{OUT} plus the voltage drop across diode 113. And as shown by plot 202, the coil current I_{L} through inductor 111 may decrease with time during the off-time of switch 112. In DCM, the switch may remain off for a period of time after the coil current I_{L} through inductor 111 reaches zero. As shown in plot 203, when switch 112 remains off after the coil current I_{L} reaches zero, the voltage V_{D} at the drain of switch 112 may decrease sharply and then oscillate. Boost converter 110 may thus produce an oscillation signal at the drain of switch 112 after the coil current I_{L} reaches zero during the off-time of switch 112. When operating in DCM, the switching loss associated with turning on switch 112 may be reduced by turning on switch 112 at a time when the voltage V_{D} at the drain of switch 112 is low. Thus, as described in further detail below, PFC control circuit 170 may detect the valleys of the oscillation signal produced by boost converter 110 at the drain of switch 112 to align the turn-on time of switch 112 with a low portion of a selected valley.

Referring back to FIG. 1, the output voltage V_{OUT} of boost converter 110 may be regulated by controlling the on-and-off switching of switch 112. PFC control circuit 170 may provide a signal VGATE to the gate of switch 112 to control the switching of boost converter 110. PFC control circuit 170 may receive various inputs for controlling the switching of boost converter 110 and also the conduction mode in which boost converter 110 operates. In some embodiments, PFC control circuit 170 may receive one or more inputs from, for example, feedback network 120, power-output monitor 130, rectifier circuit 140, current-sense circuit 150, and zero-cross circuit 160. In some embodiments, PFC control circuit 170 may utilize one or more of such inputs to control whether boost converter 110 operates in CCM, CrM, or DCM.

Feedback network 120 may be implemented in any suitable fashion according to the operation described in the present disclosure. In some embodiments, feedback network 120 may include feedback resistors 121 and 122. Feedback resistors 121 and 122 may be coupled in series to form a resistor divider between output 116 and ground GND. The intermediate node between feedback resistors 121 and 122 may thus provide a feedback signal V_{FB} that may be representative of the output voltage V_{OUT} of boost converter 110. Feedback resistors 121 and 122 may be sized to have large resistance values, for example, in the range of Kilo-Ohms, Mega-Ohms, or higher, such that the current drawn and consumed by feedback resistors 121 and 122 is insubstantial relative to the output current drawn by load 190. FIG. 1 illustrates an embodiment of feedback network 120 including feedback resistors 121 and 122 that may generate a feedback signal V_{FB} in the form of a voltage proportional to the output voltage V_{OUT}. In other embodiments, feedback network 120 may include any components, such as an optocoupler or a buffer circuit, suitable to generate any form of feedback signal, such as a voltage signal or a current signal, suitable to communicate a value representative of the output voltage V_{OUT}. The feedback signal V_{FB} may be provided to PFC control circuit 170. As described below, PFC control circuit 170 may regulate the output voltage V_{OUT} and the average coil current I_{L} of boost converter 110, and may control the operating mode of boost converter 110, based in part on the feedback signal V_{FB}.

Power-output monitor 130 may be implemented in any suitable fashion according to the operation described in the present disclosure. Power-output monitor 130 may monitor the output voltage V_{OUT} and the output current I_{OUT} and generate an output-power signal P_{OUT} to be provided to PFC control circuit 170. Power-output monitor 130 may determine the output power by, for example, multiplying a measure of the output voltage V_{OUT} by a measure of the output current I_{OUT} (P_{OUT}=V_{OUT}*I_{OUT}). Although the output-power signal P_{OUT} may represent the output power, the signal may take any form, such as a voltage or a current, suitable for communicating a value of the output power to PFC control circuit 170. As described below, PFC control circuit 170 may regulate the output voltage V_{OUT} and the average coil current I_{L} of boost converter 110, and may control the operating mode of boost converter 110, based in part on the output-power signal P_{OUT}.

Rectifier circuit 140 may be implemented in any suitable fashion according to the operation described in the present disclosure. Rectifier circuit 140 may include diodes 141 and 142 and resistor 143. As shown in FIG. 1, the anodes of diodes 141 and 142 may be respectively coupled to the opposing AC lines at the output of EMI filter 101. The cathodes of diodes 141 and 142 may be coupled together and to resistor 143. Rectifier circuit 140 may thus rectify the AC signal filtered by EMI filter 101 to generate a full-wave rectified signal AC_{RECT}. Rectifier circuit 140 may provide the full-wave rectified signal AC_{RECT} to PFC control circuit 170. And as described below, PFC control circuit 170 may regulate the output voltage V_{OUT} and the average coil current I_{L} of boost converter 110, and may control the operating mode of boost converter 110, based in part on the full-wave rectified signal AC_{RECT}.

Current-sense circuit 150 may be implemented in any suitable fashion according to the operation described in the present disclosure. Current-sense circuit 150 may include resistor 151, resistor 152, and capacitor 153. Resistor 151 may be coupled in the current return path between ground GND and the negative output terminal of diode bridge 102. The voltage generated across resistor 151 may thus serve as a current-sense signal CS that represents the instantaneous coil current through inductor 111. Resistor 152 and capacitor 153 may be coupled in series between the node of the current-sense signal CS and ground GND. Resistor 152 and capacitor 153 may be configured as an RC filter that filters the current-sense signal CS to provide an average current-sense signal CS_{AVG}. FIG. 1 illustrates an embodiment where resistors and capacitors are utilized to generate a current-sense signal CS and an average current-sense signal CS_{AVG} in the form of voltages representing the instantaneous coil current and the average coil current through inductor 111. In other embodiments, current-sense circuit 150 may utilize any other suitable circuitry to generate signals that may take any form, such as voltage or current, suitable to communicate values representing one or both of the instantaneous coil current and the average coil current through inductor 111.

As shown in FIG. 1, both the current-sense signal CS and the average current-sense signal CS_{AVG} may be provided to PFC control circuit 170. And as described below, PFC control circuit 170 may regulate the output voltage V_{OUT} and the average coil current I_{L} of boost converter 110, and may control the operating mode of boost converter 110, based in part on the current-sense signal CS and the average current-sense signal CS_{AVG}.

Zero-cross circuit 160 may be implemented in any suitable fashion according to the operation described in the present disclosure. Zero-cross circuit 160 may include capacitor 161, diode 162, and resistor 163. As shown in FIG. 1, capacitor 161 may be coupled between the drain of switch 112 and node 165. Diode 162 may be coupled between node 165 and ground GND. Diode 162 may be oriented such that its cathode is coupled to node 165 and its anode is coupled to ground GND. Resistor may be coupled between node 165 and ground GND. As described above with reference to FIG. 2, the voltage V_{D} at the drain of switch 112 may decrease sharply and then oscillate when the coil current I_{L} reaches zero and switch 112 remains off in DCM operating mode. Capacitor 161 capacitively couples the drain of switch 112 to node 165. Zero-cross circuit 160 may thus generate a zero-cross detect signal ZCD at node 165. As shown in FIG. 1, zero-cross circuit 160 may provide the zero-cross detect signal ZCD to PFC control circuit 170. And as described below, PFC control circuit 170 may regulate the output voltage V_{OUT} and the average coil current I_{L} of boost converter 110, and may control the operating mode of boost converter 110, based in part on the zero-cross detect signal ZCD.

PFC control circuit 170 may be implemented in any suitable fashion according to the operation described in the present disclosure. PFC control circuit 170 may utilize an average current-mode control scheme to control switch 112 to regulate the output of boost converter 110 while maintaining high power factor. As described below, PFC control circuit 170 may utilize the same average current-mode control scheme for different operating modes of boost converter 110, including CCM, CrM, and DCM. Thus, PFC controller may seamlessly transition between the different CCM, CrM, and DCM operating modes within each single half-cycle of the AC line voltage received at the AC input.

PFC control circuit 170 may include reference generator 172, voltage regulation circuit 174, multiplier 175, current regulation circuit 176, mode control circuit 178, and pulse width modulation (“PWM”) circuit 180. In some embodiments, one or more components of PFC control circuit 170 may be integrated on a semiconductor die to form an integrated circuit. One or more other components of PFC circuit 100, for example switch 112 or feedback resistors 121 and 122, may also be integrated on a semiconductor die with the components of PFC control circuit 170 to form an integrated circuit. In some embodiments, components of PFC control circuit 170 and other components of PFC circuit 100, such as switch 112, may be implemented on multiple semiconductor die and co-packaged in a single multi-chip integrated circuit package.

Reference generator 172 may receive the full-wave rectified signal AC_{RECT} from rectifier circuit 140. Reference generator 172 may also receive the output-power signal P_{OUT} from power-output monitor 130. Based on the full-wave rectified signal AC_{RECT} and the output-power signal P_{OUT} signal, reference generator 172 may generate a reference signal REF_{P}.

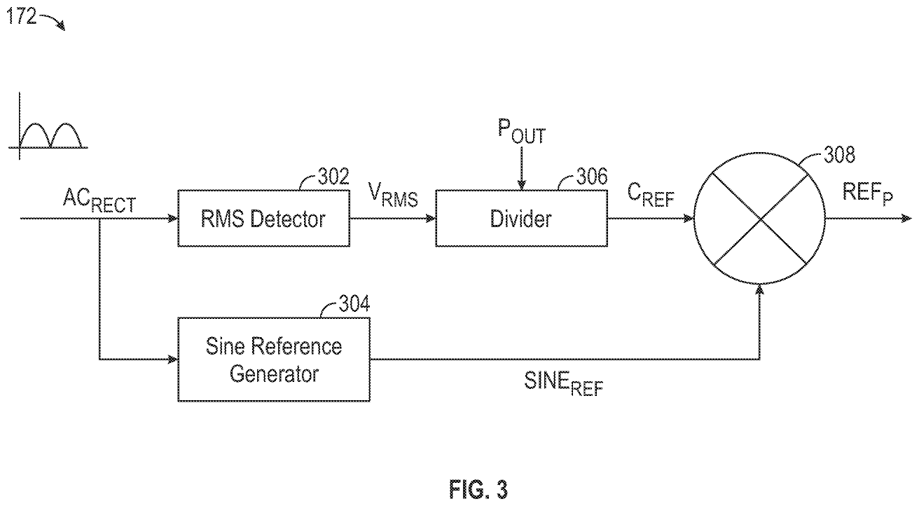

FIG. 3 illustrates a block diagram of reference generator 172 in accordance with embodiments of the present disclosure. Reference generator 172 may be implemented in any suitable fashion according to the operation described in the present disclosure. Reference generator 172 may include RMS detector 302, sine reference generator 304, divider 306, and multiplier 308. RMS detector 302 may receive the full-wave rectified signal AC_{RECT}. Based on the full-wave rectified signal AC_{RECT}, RMS detector 302 may generate a signal V_{RMS} representing the root-mean-square of AC_{RECT}. Divider 306 may then divide the output-power signal P_{OUT} by V_{RMS} to generate a current reference signal C_{REF}. Although the current reference signal C_{REF} may represent the output-power signal P_{OUT} divided by V_{RMS}, the signal may take any suitable form, such as a voltage or a current, for communicating the output value of divider 306. Sine reference generator 304 may generate a full-wave rectified sine wave signal SINE_{REF} with a phase that is synchronized to the full-wave rectified signal AC_{RECT}. Although the phase of SINE_{REF} may be synchronized to the phase of AC_{RECT}, SINE_{REF} may in some embodiments be normalized such that its amplitude does not depend on the amplitude of AC_{RECT}. Multiplier 308 may multiply C_{REF} by SINE_{REF} to generate the reference signal REF_{P}.

Referring back to FIG. 1, PFC control circuit 170 may include voltage regulation circuit 174, multiplier 175, current regulation circuit 176, and PWM circuit 180. Voltage regulation circuit 174, multiplier 175, current regulation circuit 176, and PWM circuit 180 may work in conjunction to regulate the output voltage V_{OUT} of boost converter 110 while also regulating the average coil current of inductor 111 in boost converter 110. Voltage regulation circuit 174 may form part of what may be referenced as the outer regulation loop or the outer voltage regulation loop. Current regulation circuit 176 may form part of what may be referenced as the inner regulation loop or the inner current regulation loop.

Voltage regulation circuit 174 may be implemented in any suitable fashion according to the operation described in the present disclosure. Voltage regulation circuit 174 may receive the feedback signal V_{FB} from feedback network 120. As described above, the feedback signal V_{FB} may be representative of the output voltage V_{OUT}. Voltage regulation circuit 174 may generate a voltage regulation signal V_{REG} based on the difference between the feedback signal V_{FB} and a voltage reference V_{ref} representative of the desired output voltage. Accordingly, voltage regulation circuit 174 may, in conjunction with multiplier 175, current regulation circuit 176, and PWM circuit 180, regulate the output voltage V_{OUT} of boost converter 110 by modulating V_{REG} based on the feedback signal V_{FB}.

Multiplier 175 may be implemented in any suitable fashion according to the operation described in the present disclosure. Multiplier 175 may multiply or attenuate the reference signal REF_{P} based on the voltage regulation signal V_{REG} from voltage regulation circuit 174 to generate the reference signal REF_{I} to be used by current regulation circuit 176 and mode control circuit 178.

Current regulation circuit 176 may be implemented in any suitable fashion according to the operation described in the present disclosure. Current regulation circuit 176 may receive the reference signal REF_{I} from multiplier 175 and the average current-sense signal CS_{AVG} from current-sense circuit 150. Current regulation circuit 176 may generate a current-regulation signal IREG based on CS_{AVG} and the reference signal REF_{I}. For example, current regulation circuit 176 may modulate IREG based on the difference between CS_{AVG} and the reference signal REF_{I}. Current regulation circuit 176 may provide IREG to PWM circuit 180. Accordingly, current regulation circuit 176 may, in conjunction with PWM circuit 180, regulate the average coil current of inductor 111 in boost converter 110 by modulating IREG based on the difference between CS_{AVG} and the reference signal REF_{I}.

PWM circuit 180 may be implemented in any suitable fashion according to the operation described in the present disclosure. PWM circuit 180 may include a driver that drives the gate of switch 112, and thus controls the on-and-off switching cycles of switch 112. PWM circuit 180 may pulse-width modulate the on-time, and thus the duty cycle, of switch 112 during each switching cycle based at least in part on IREG. Accordingly, current regulation circuit 176 may, in conjunction with PWM circuit 180, regulate the average coil current of inductor 111 in boost converter 110 by modulating the IREG signal provided to PWM circuit 180 based on the difference between CS_{AVG} and the reference signal REF_{I}. As described below, PWM circuit 180 may initiate the beginning of a given switching cycle in response to a trigger signal from mode control circuit 178. Thus, PWM circuit 180 may determine when to initiate a given switching cycle based on the trigger signal from mode control circuit 178, and may also control the on-time of that switching cycle based on the IREG signal from current regulation circuit 176.

As shown in FIG. 1, PFC control circuit 170 may include mode control circuit 178. Mode control circuit 178 may provide a trigger signal to PWM circuit 180 to control the beginning point of each switching cycle. For example, based on the trigger signal, PWM circuit 180 may control when switch 112 is turned on to begin the next switching cycle. As described above, in CCM operating mode, a new switching cycle may be initiated by turning the switch on before the coil current I_{L} discharges to zero during the off-time of the previous switching cycle. In CrM operating mode, a new switching cycle may be initiated by turning the switch on immediately or soon after the coil current I_{L} reaches zero during the off-time of the previous switching cycle. By contrast, in DCM operating mode, the coil current I_{L} may be allowed to decay to zero and switch 112 may subsequently remain off for a period of time before the switch 112 is again turned on to initiate the next switching cycle. Thus, by controlling the beginning point of each switching cycle, mode control circuit 178 may control whether boost converter 110 operates in CCM, CrM, or DCM.

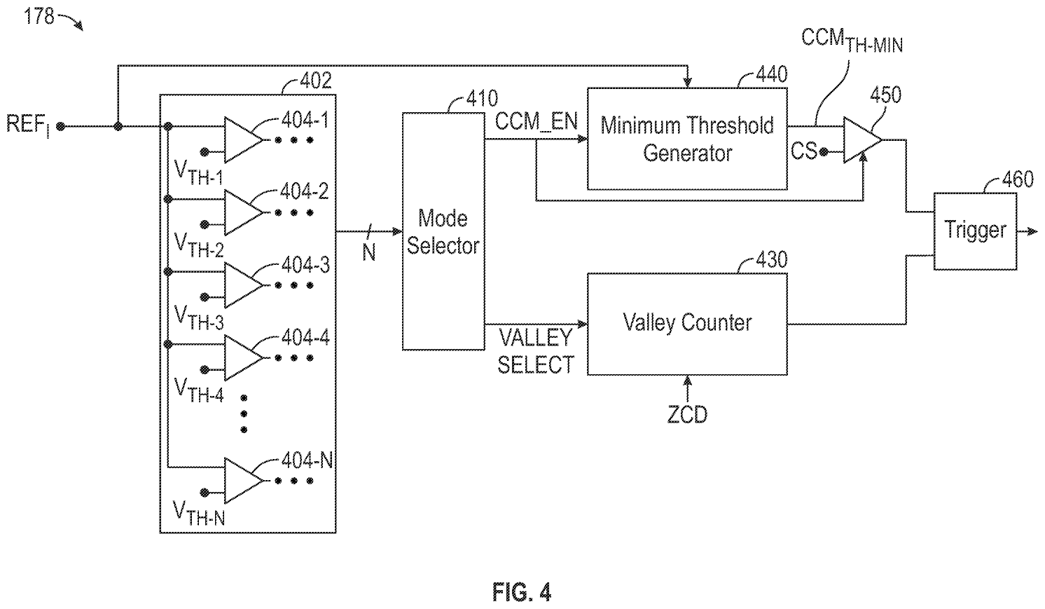

Mode control circuit 178 may be implemented in any suitable fashion according to the operation described in the present disclosure. FIG. 4 illustrates a block diagram of mode control circuit 178 in accordance with embodiments of the present disclosure. In some embodiments, mode control circuit 178 may include a comparator array 402, mode selector 410, valley counter 430, minimum threshold generator 440, comparator 450, and trigger 460.

Comparator array 402 may be implemented in any suitable fashion according to the operation described in the present disclosure. Comparator array 402 may receive the reference signal REF_{I} and may include an N number of comparators 404-1, 404-2, 404-3, 404-4, . . . and 404-N, that respectively compare REF_{I} against an N number of thresholds V_{TH-1}, V_{TH-2}, V_{TH-3}, V_{TH-4}, . . . and V_{TH-N}. The outputs from individual comparators 404-1 through 404-N within comparator array 402 may be provided to mode selector 410. Based on the outputs of comparator array 402, mode selector 410 may select and enable one of the CCM operating mode, CrM operating mode, or DCM operating mode.

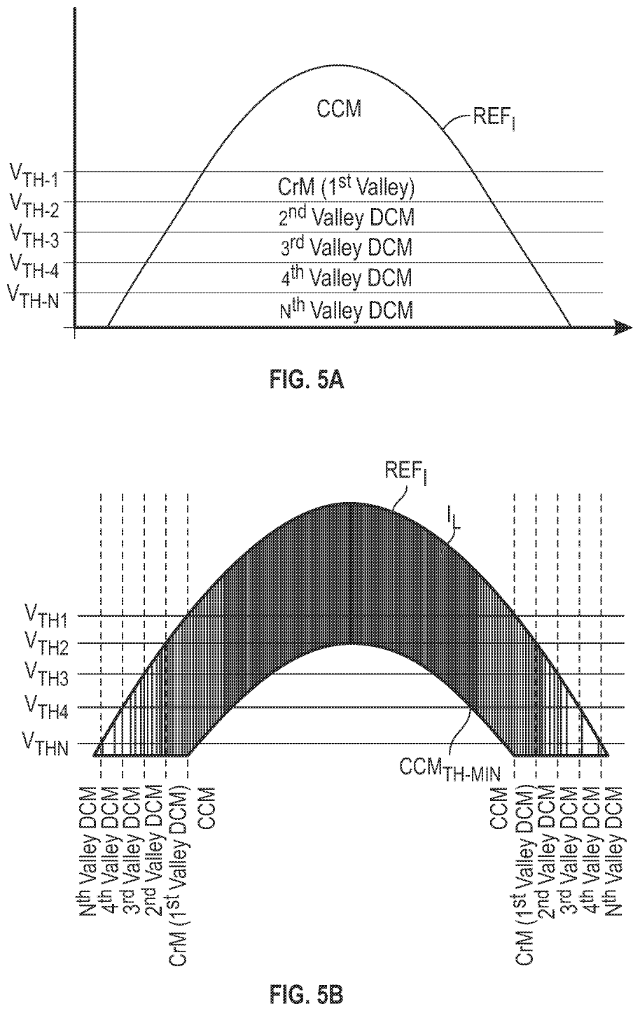

FIG. 5A illustrates a plot diagram of the reference signal REF_{I} versus an N number of thresholds V_{TH-1}, V_{TH-2}, V_{TH-3}, V_{TH-4}, . . . and V_{TH-N}, for determining the operating mode of boost converter 110 in accordance with embodiments of the present disclosure. As described above with reference to FIG. 1, to generate REF_{I}, multiplier 175 may multiply or attenuate the reference signal REF_{P} based on the voltage regulation signal V_{REG} from voltage regulation circuit 174. And as described above with reference to FIG. 3, REF_{P} may be generated based in part on the output-power signal P_{OUT}. Thus, REF_{I} may have an amplitude based at least in part on the output power of boost converter 110. Moreover, the reference signal REF_{P} may be generated by multiplying C_{REF} by the full-wave rectified sine wave signal SINE_{REF}, which may have a phase synchronized to that of the full-wave rectified signal AC_{RECT}. Accordingly, the reference signal REF_{I} may be a cyclic signal with the shape of a full-wave rectified AC signal that is in phase with AC_{RECT} and the AC line voltage received at the AC input of PFC circuit 100. Mode selector 410 may thus cyclically select different modes of operation, including DCM, CrM, and CCM, at different times as REF_{I} traverses its full-wave rectified shape during each half-cycle of the AC line voltage at the AC input. For example, as REF_{I} traverses its full-wave rectified shape during a half-cycle of the AC line voltage, mode selector 410 may cycle the mode selection as follows: DCM to CrM to CCM to CrM to DCM, then starting over at the beginning of a new half-cycle of the AC line voltage. Moreover, the selection of the different conduction modes at different times within each half-cycle of the AC line voltage may also account for the output power of boost converter 110.

Mode selector 410 may be implemented in any suitable fashion according to the operation described in the present disclosure. As shown in FIG. 5A, mode selector 410 may select and enable CCM mode of operation when REF_{I} is greater than the first threshold V_{TH-1}. Conversely, mode selector 410 may select and enable one of the CrM and DCM modes of operation when REF_{I} is less than the first threshold V_{TH-1}. For example, when REF_{I} is between the first threshold V_{TH-1} and the second V_{TH-2}, mode selector 410 may select the first valley to trigger the beginning of the next switching cycle. As further examples, mode selector 410 may select one of the second, third, fourth, . . . or Nth valleys based on the value of REF_{I} relative to the second, third, fourth, . . . and Nth thresholds, to trigger the beginning of the next switching cycle. Referring back to FIG. 2, the first valley occurs immediately after the coil current I_{L} of inductor 111 reaches zero during the off-time of switch 112. Thus, by selecting the first valley to trigger the beginning of the next switching cycle, mode selector 410 may select and enable the CrM operating mode. As also shown in FIG. 2, the subsequent second, third, fourth, . . . and Nth valleys occur after the coil current I_{L} of inductor 111 reaches zero and switch 112 remains off for a period of time. Thus, by selecting any of the second, third, fourth, . . . or Nth valleys, mode selector 410 may select and enable the DCM operating mode.

Although FIG. 5A illustrates the selection of each of three operating modes—CCM, CrM, and DCM—at different points in time as REF_{I} traverses its full-wave rectified shape during each half-cycle of the AC line voltage at the AC input, mode selector 410 may also be configured in some embodiments to select from between two operating modes. For example, in some embodiments, mode selector 410 may be configured to select CCM operation when REF_{I} is above V_{TH-1}, and to select DCM operation (at any of the second, third, fourth, or Nth valleys) when REF_{I} is below V_{TH-1}.

Referring back to FIG. 4, mode selector 410 may select and enable the CCM operating mode by sending a CCM enable signal CCM_EN to components of mode control circuit 178 that implement CCM operation. For example, mode selector 410 may send a CCM enable signal CCM_EN to minimum threshold generator 440 and comparator 450.

Minimum threshold generator 440 may be implemented in any suitable fashion according to the operation described in the present disclosure. Minimum threshold generator 440 may generate a minimum coil current threshold CCM_{TH-MIN} based at least in part on REF_{I}. The minimum coil current threshold CCM_{TH-MIN} may control the minimum coil current I_{L} (during the off-time of switch 112) at which switch 112 will be switched on to begin the next switching cycle during CCM operation. For example, comparator 450 may compare CCM_{TH-MIN} against the current-sense signal CS, which is indicative of the coil current I_{L} of inductor 111. When the coil current I_{L} of inductor 111 reaches the minimum coil current threshold CCM_{TH-MIN}, comparator 450 may trip trigger 460. Referring back to FIG. 1, PWM circuit 180 may in turn initiate the next switching cycle by switching on switch 112 in response to the trigger signal from trigger 460 within mode control circuit 178.

FIG. 5B illustrates a plot diagram of the current regulation reference signal REF_{I} and the minimum coil current threshold CCM_{TH-MIN} in accordance with embodiments of the present disclosure. The minimum coil current threshold CCM_{TH-MIN} may be generated by applying a negative offset to the reference signal REF_{I}. In some embodiments, the minimum value of CCM_{TH-MIN} may be clamped, for example at 0 volts. As described above with reference to FIG. 1, REF_{I} may also be used as the reference for the current regulation circuit 176. The amount of offset between REF_{I} and the minimum coil current threshold CCM_{TH-MIN} may thus control the ripple of the coil current I_{L} of inductor 111 when operating in CCM. Moreover, the switching frequency of boost converter 110 may vary during CCM based on multiple factors, including for example, the ripple of the coil current I_{L} of inductor 111 as controlled by the minimum coil current threshold CCM_{TH-MIN}, the voltage at the input of boost converter 110, the output voltage V_{OUT} at output 116 of boost converter 110, and the inductance value of inductor 111.

Different amounts of ripple current may be desired based on the operating conditions and/or the applications in which embodiments of PFC circuit 100 may be used. For example, different amounts of ripple current during CCM may be desired depending on the size of the inductor 111 used in boost converter 110. Moreover, different amounts of ripple current may be desired based on the amplitude of the AC line voltage received at the AC input, for example whether the AC input receives an AC line voltage of 120 volts or 240 volts. In some embodiments, minimum threshold generator 440 may generate CCM_{TH-MIN} based on a static offset that is tailored to the particular application in which PFC circuit 100 is to be used. In some embodiments, minimum threshold generator 440 may generate CCM_{TH-MIN} based on a programmable offset, which may enable a user to tailor the offset to different applications for PFC circuit 100. And in some embodiments, minimum threshold generator 440 may generate CCM_{TH-MIN} based on an offset that is responsive to operating conditions of PFC circuit 100, such as the amplitude of the AC line voltage received at the AC input.

Referring back to FIG. 4, mode selector 410 may also select and enable one of the CrM and DCM modes of operation. In some embodiments, mode selector 410 may select and enable one of the CrM and DCM modes of operation by sending a VALLEY SELECT signal to valley counter 430. In other embodiments, mode selector 410 may enable CrM and DCM mode by sending a separate enable signal (not shown) to valley counter 430, and then selecting between CrM and DCM mode based on the value of the VALLEY SELECT signal. As described above with reference to FIG. 5A, the selection of the first valley may enable CrM operation while the selection of any of the second, third, fourth, . . . or Nth valley may enable DCM operation.

Valley counter 430 may be implemented in any suitable fashion according to the operation described in the present disclosure. Valley counter 430 may utilize the zero-cross detect signal ZCD from zero-cross circuit 160 to detect the valleys of the oscillation signal present at the drain of switch 112 after the coil current I_{L} of inductor 111 reaches zero during the off-time of switch 112. For example, as shown in FIG. 1, capacitor 161 may capacitively couple the drain of switch of 111 to node 165. The zero-cross detect signal ZCD at node 165 may thus have a negative slope at the beginning of each valley due to the negative slope of V_{D} at the beginning of each valley. Valley counter 430 may utilize the negative slope of ZCD to detect and count each valley of the oscillation signal present at the drain of switch 112. When the valley count reaches the number indicated by the VALLEY SELECT signal, valley counter 430 may trip trigger 460. Referring back to FIG. 1, PWM circuit 180 may in turn initiate the next switching cycle by turning on switch 112 in response to a trigger signal from trigger 460 within mode control circuit 178.

As described above with reference to FIG. 5A, the reference signal REF_{I} may be a cyclic signal with the shape of a full-wave rectified AC signal that is in phase with AC_{RECT} and the AC line voltage received at the AC input of PFC circuit 100. Mode selector 410 may cyclically select different modes of operation, including DCM, CrM, and CCM, at different times as REF_{I} traverses its full-wave rectified shape during each half-cycle of the AC input. Moreover, PFC control circuit 170 may utilize the same regulation loop, including voltage regulation circuit 174, current regulation circuit 176, and PWM circuit 180, during each mode of operation, including DCM, CrM, and CCM. Accordingly, PFC control circuit 170 may advantageously provide for seamless transitions between different operating modes, including DCM, CrM, and CCM, within each half-cycle of the AC input.

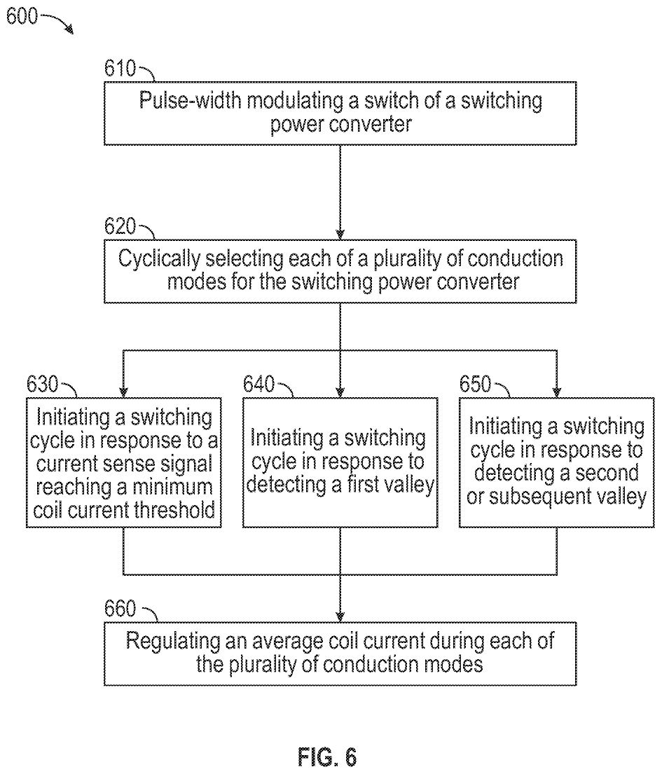

FIG. 6 illustrates operation of an example method 600 for controlling a PFC circuit in accordance with embodiments of the present disclosure. Method 600 may be performed by any suitable mechanism, such as PFC control circuit 170. Method 600 may be performed with fewer or more steps than shown in FIG. 6. Moreover, steps of method 600 may be omitted, repeated, performed in parallel, performed in a different order than shown in FIG. 6, or performed recursively. One or more steps of method 600, although shown in an order, may be performed at the same time or in a re-ordered manner.

At step 610, a switch of a switching power converter may be pulse-width modulated. For example, boost converter 110 may include switch 112. PWM circuit 180 may drive the gate of switch 112 and thus control the on-and-off switching cycles of switch 112. Based on the current-regulation signal IREG from current regulation circuit 176, PWM circuit 180 may modulate the pulse width of the on-time of switch 112 during each switching cycle.

At step 620, each of a plurality of conduction modes for the switching power converter may be cyclically selected. For example, as described above with reference to FIG. 4, comparator array 402 may include a plurality of comparators 404-1, 404-2, 404-3, 404-4, . . . and 404-N, configured to compare a reference signal REF_{I} against a plurality of thresholds. Comparator array 402 may provide the results of the comparisons to mode selector 410. As described above with reference to FIG. 1 and FIG. 5A, the reference signal REF_{I} may be a cyclic signal that may have the shape of a full-wave rectified AC signal and may also depend in part on the output-power signal P_{OUT}. Mode selector 410 may thus cyclically select different modes of operation, including DCM, CrM, and CCM, based on the comparison of the cyclic reference signal, REF_{I}, to the plurality of thresholds. Moreover, the selection of the different conduction modes at different times within each half-cycle of the AC line voltage may also be based at least in part on the output power of boost converter 110.

When CCM operation is selected, method 600 may perform step 630. At step 630, a switching cycle may be initiated in response to a current-sense signal reaching a minimum coil current threshold. For example, minimum threshold generator 440 may generate a minimum coil current threshold CCM_{TH-MIN} based at least in part on REF_{I}. The minimum coil current threshold CCM_{TH-MIN} may control the minimum coil current I_{L} (during the off-time of switch 112) at which switch 112 will be turned on to begin the next switching cycle. For example, comparator 450 may compare CCM_{TH-MIN} against the current-sense signal CS, which may be indicative of the coil current I_{L} of inductor 111. When the coil current I_{L} of inductor 111 reaches the minimum coil current threshold CCM_{TH-MIN}, comparator 450 may trip trigger 460. Referring back to FIG. 1, PWM circuit 180 may in turn initiate the next switching cycle by turning on switch 112 in response to the trigger signal from trigger 460 within mode control circuit 178.

When CrM operation is selected, method 600 may perform step 640. At step 640, a switching cycle may be initiated in response to detecting a first valley. For example, as shown in FIG. 2, boost converter 110 may produce an oscillation signal at the drain of switch 112 after the coil current I_{L} reaches zero during the off-time of switch 112. The first valley occurs immediately after the coil current I_{L} of inductor 111 reaches zero during the off-time of switch 112. When REF_{I} is between the first threshold V_{TH-1} and the second V_{TH-2}, mode selector 410 may select the first valley to trigger the beginning of the next switching cycle. In response to detecting the first valley of the oscillation signal, valley counter 430 may trip trigger 460, which may in turn instruct PWM circuit 180 to initiate the next switching cycle by turning on switch 112.

When DCM operation is selected, method 600 may perform step 650. At step 650, a switching cycle may be initiated in response to detecting a second or subsequent valley. For example, as shown in FIG. 2, boost converter 110 may produce an oscillation signal at the drain of switch 112 after the coil current I_{L} reaches zero during the off-time of switch 112. The second, third, fourth, . . . and Nth valleys occur a period of time after the coil current I_{L} of inductor 111 reaches zero during the off-time of switch 112. For DCM operation, mode selector 410 may select any of the second, third, further, . . . or Nth valleys to trigger the beginning of the next switching cycle. In response to detecting the selected valley of the oscillation signal, valley counter 430 may trip trigger 460, which may in turn instruct PWM circuit 180 to initiate the next switching cycle by turning on switch 112.

At step 660, an average coil current may be regulated during each of the plurality of conduction modes. For example, current regulation circuit 176 may receive the reference signal REF_{I} from multiplier 175 and the average current-sense signal CS_{AVG} from current-sense circuit 150. Current regulation circuit 176 may generate a current-regulation signal IREG based on CS_{AVG} and the reference signal REF_{I}. Current regulation circuit 176 may modulate IREG based on, for example, the difference between CS_{AVG} and the reference signal REF_{I}. Current regulation circuit 176 may provide IREG to PWM circuit 180, which controls the on-and-off switching of switch 112. Thus, in conjunction with PWM circuit 180, current regulation circuit 176 may regulate the average coil current of inductor 111 in boost converter 110 by modulating IREG based on the difference between CS_{AVG} and the reference signal REF_{I}.

Although examples have been described above, other modifications and variations may be made from this disclosure without departing from the spirit and scope of these examples. The above descriptions of various embodiments illustrate the principles of the invention. Numerous variations and modifications will become apparent to those skilled in the art based on the above disclosure. The following claims are intended to embrace all such variations and modifications.

What is claimed is:

1. A power factor correction (PFC) control circuit, comprising:
a pulse-width modulation (PWM) circuit configured to control a switch of a switching power converter;
a mode control circuit configured to select a conduction mode from a plurality of conduction modes for the switching power converter and to control a beginning of a switching cycle of the switching power converter based on the selected conduction mode; and
a current regulation circuit configured to provide a regulation signal to the PWM circuit to regulate an average coil current of the switching power converter in each of the plurality of conduction modes.

2. The PFC control circuit of claim 1, wherein the plurality of conduction modes for the switching power converter includes a continuous conduction mode and one or more of a critical conduction mode and a discontinuous conduction mode.

3. The PFC control circuit of claim 1, wherein the mode control circuit is configured to cyclically select each of the plurality of conduction modes at different times within a period of a half-cycle of an AC line voltage received at an AC input of the switching power converter.

4. The PFC control circuit of claim 1, wherein the mode control circuit is configured to select the conduction mode based at least in part on an output power of the switching power converter.

5. The PFC control circuit of claim 1, wherein the mode control circuit comprises:
a threshold generator configured to generate a minimum coil current threshold; and
a comparator configured to compare the minimum coil current threshold against a current-sense signal indicating a coil current of the switching power converter.

6. The PFC control circuit of claim 5, wherein the mode control circuit is configured to send a trigger signal to the PWM circuit to control the beginning of the switching cycle in response to the comparator when a continuous conduction mode has been selected from among the plurality of conduction modes.

7. The PFC control circuit of claim 1, wherein the mode control circuit comprises a valley counter configured to detect valleys of an oscillation signal present at a node of the switching power converter after a coil current of the switching power converter has reached zero.

8. The PFC control circuit of claim 7, wherein the mode control circuit is configured to send a trigger signal to the PWM circuit to control the beginning of the switching cycle in response to the valley counter when a critical conduction mode or a discontinuous conduction mode has been selected from among the plurality of conduction modes.

9. A power factor correction (PFC) circuit, comprising:
a boost converter including a switch and an inductor;
a feedback network configured to generate a feedback signal representative of an output voltage of the boost converter; and
a power factor correction control circuit, comprising:
a pulse-width modulation (PWM) circuit configured to control the switch of the boost converter;
a mode control circuit configured to select a conduction mode from a plurality of conduction modes for the boost converter and to control a beginning of a switching cycle of the boost converter based on the selected conduction mode;
a voltage regulation circuit configured to regulate the output voltage based at least in part on the feedback signal; and
a current regulation circuit configured to provide a regulation signal to the PWM circuit to regulate an average coil current of the boost converter in each of the plurality of conduction modes.

10. The PFC circuit of claim 9, wherein the plurality of conduction modes for the boost converter includes a continuous conduction mode and one or more of a critical conduction mode and a discontinuous conduction mode.

11. The PFC circuit of claim 9, wherein the mode control circuit is configured to select the conduction mode based at least in part on an output power of the switching power converter.

12. The PFC circuit of claim 9, wherein the mode control circuit comprises:
a threshold generator configured to generate a minimum coil current threshold; and
a comparator configured to compare the minimum coil current threshold against a current-sense signal indicating a coil current of the boost converter; and
wherein the mode control circuit is configured to send a trigger signal to the PWM circuit to control the beginning of the switching cycle in response to the comparator when a continuous conduction mode has been selected from among the plurality of conduction modes.

13. The PFC circuit of claim 9, wherein:
the mode control circuit comprises a valley counter configured to detect valleys of an oscillation signal present at a node of the boost converter after a coil current of the boost converter has reached zero; and
the mode control circuit is configured to send a trigger signal to the PWM circuit to control a beginning of the switching cycle in response to the valley counter when a critical conduction mode or a discontinuous conduction mode has been selected from among the plurality of conduction modes.

14. A method for controlling a power factor correction (PFC) circuit, comprising:
pulse-width modulating a switch of a switching power converter;
cyclically selecting each of a plurality of conduction modes for the switching power converter at different times within each half-cycle of an AC line voltage received at an AC input of the switching power converter; and
regulating an average coil current of the switching power converter with a current regulation circuit during each of the plurality of conduction modes.

15. The method of claim 14, wherein the plurality of conduction modes includes a continuous conduction mode and one or more of a critical conduction mode and a discontinuous conduction mode.

16. The method of claim 14, wherein cyclically selecting each of the plurality of conduction modes comprises:
generating a cyclic reference signal with a shape of a full-wave rectified AC signal that is in phase with the AC line voltage; and
comparing the cyclic reference signal against a plurality of thresholds.

17. The method of claim 14, wherein cyclically selecting each of the plurality of conduction modes comprises selecting a conduction mode based at least in part on an output power of the switching power converter.

18. The method of claim 14, further comprising:
generating a minimum coil current threshold;
comparing the minimum coil current threshold against a current-sense signal indicating a coil current of the switching power converter; and
when operating the switching power converter in a continuous conduction mode, turning the switch on to initiate a switching cycle of the switching power converter in response to the current-sense signal reaching the minimum coil current threshold.

19. The method of claim 14, further comprising:
detecting a first valley of an oscillation signal present at a node of the switching power converter after a coil current of the switching power converter has reached zero; and
when operating the switching power converter in a critical conduction mode, turning the switch on to initiate a switching cycle of the switching power converter in response to detecting the first valley of the oscillation signal.

20. The method of claim 14, further comprising:
detecting a plurality of valleys of an oscillation signal present at a node of the switching power converter after a coil current of the switching power converter has reached zero; and
when operating the switching power converter in a discontinuous conduction mode, turning the switch on to initiate a switching cycle of the switching power converter in response to detecting a second or subsequent valley of the oscillation signal.
